(19) United States
(12) Patent Application Publication
(10) Pub. No.: US 2026/0145407 A1
(43) Pub. Date: May 28, 2026

(54) LAMINATED GLAZING HAVING IMPROVED SENSOR COMPATIBILITY

(71) Applicant: Solutia Inc., St. Louis, MO (US)

(72) Inventor: Howard Donald Booth, JR., Westfield, MA (US)

(73) Assignee: Solutia Inc., St. Louis, MO (US)

(21) Appl. No.: 19/103,567

(22) PCT Filed: Aug. 16, 2023
(86) PCT No.: PCT/US2023/072262

§ 371 Date: Feb. 13, 2025

Related U.S. Application Data
(60) Provisional application No. 63/373,043, filed on Aug. 19, 2022.

(51) Int. Cl. B32B 17/10

(52) U.S. Cl. CPC B32B 17/10036; B32B 17/10339; B32B 17/10449; B32B 17/10761; B32B 17/10779; B32B 17/10816; B32B 17/1099; B32B 2250/03; B32B 2250/40; B32B 2307/4026; B32B 2307/412; B32B 2329/06; B32B 2367/00

(57) ABSTRACT

Multiple layer panels comprising a first rigid substrate, a polymer interlayer, and a second rigid substrate, a first rigid substrate, a first polymer interlayer, and a second rigid substrate, wherein the multiple layer panel has a sensor area for at least a first sensor and a second sensor, and wherein the first polymer interlayer has a solar absorbing capability having a first visible light transmission, wherein the first sensor area comprises a second polymer interlayer selected to allow a first optically transparent area in the first sensor area, wherein the first optically transparent area has a second light transmission selected to allow a first sensor to operate, and wherein the second sensor area comprises a third polymer interlayer selected to allow a second optically transparent area in the second sensor area, wherein the second optically transparent area has a third light transmission selected to allow a second sensor to operate, wherein first polymer interlayer, the second polymer interlayer and the third polymer interlayer are different are disclosed. WO

### BACKGROUND OF THE INVENTION

### Field of the Invention

This disclosure is related to the field of polymer interlayers for multiple layer glass panels and multiple layer glass panels having at least one polymer interlayer sheet. Specifically, this disclosure is related to the field of multiple layer panels having one or more sensors comprising polymer interlayers, wherein the multiple layer panels have improved sensor compatibility.

### Description of Related Art

Multiple layer panels are generally panels comprised of two sheets of a substrate (such as, but not limited to, glass, polyester, polyacrylate, or polycarbonate) with one or more polymer interlayers sandwiched therebetween. The laminated multiple layer glass panels are commonly utilized in architectural window applications and in the windows of motor vehicles and airplanes, and in photovoltaic solar panels. The first two applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may also give the glass a much higher sound insulation rating, reduce UV and/or IR light transmission, and enhance the aesthetic appeal of the associated window. In regard to the photovoltaic applications, the main function of the interlayer is to encapsulate the photovoltaic solar panels which are used to generate and supply electricity in commercial and residential applications.

In order to achieve the certain property and performance characteristics for the glass panel, it has become common practice to utilize multiple layer or multilayered interlayers. As used herein, the terms “multilayer” and “multiple layers” mean an interlayer having more than one layer, and multilayer and multiple layer may be used interchangeably. Multiple layer interlayers typically contain at least one soft layer and at least one stiff layer. Interlayers with one soft “core” layer sandwiched between two more rigid or stiff “skin” layers have been designed with sound insulation properties for the glass panel. Interlayers having the reverse configuration, that is, with one stiff layer sandwiched between two more soft layers have been found to improve the impact performance of the glass panel and can also be designed for sound insulation. Examples of multiple layer interlayers also include the interlayers with at least one “clear” or non-colored layer and at least one colored layer or at least one conventional layer, e.g., non-acoustic layer, and at least one acoustic layer (i.e., a layer have acoustic properties or the ability to provide sound insulation or reduce sound transmission, as further defined below). Other examples of multiple layer interlayers include interlayers with at least two layers with different colors for aesthetic appeal. The colored layer typically contains pigments or dyes or some combination of pigments and dyes.

The layers of the interlayer are generally produced by mixing a polymer resin such as poly(vinyl butyral) with one or more plasticizers and melt processing the mix into a sheet by any applicable process or method known to one of skill in the art, including, but not limited to, extrusion. Multiple layer interlayers can be produced by processes such as co-extrusion or lamination wherein the layers are combined together to form a unitary structure. Other additional ingredients may optionally be added for various other purposes. After the interlayer sheet is formed, it is typically collected and rolled for transportation and storage and for later use in the multiple layer glass panel, as discussed below.

The following offers a simplified description of the manner in which multiple layer glass panels are generally produced in combination with the interlayers. First, at least one polymer interlayer sheet (single or multilayer) is placed between two substrates and any excess interlayer is trimmed from the edges, creating an assembly. It is not uncommon for multiple polymer interlayer sheets or a polymer interlayer sheet with multiple layers (or a combination of both) to be placed within the two substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

Multilayer interlayers such as a trilayer interlayer having a soft core layer and two stiffer skin layers, optionally with additional functionality such as solar absorption, color and other options are commercially available. The stiff skin layers provide handling, processing and mechanical strength of the interlayer; the soft core layer provides acoustic damping properties.

As functionality of a windshield increases, more sensors are necessary to provide this functionality. In current vehicles having laminated glass (such as a windshield) comprising two panes of glass and a polymer interlayer, there are often multiple sensors, such as light sensors, lane departure cameras, LIDAR and rain sensors, and the like. Rain sensors are one of the most common types of sensor that operate in the infrared spectrum. LIDAR, which has been primarily developed for autonomous driving applications, is a relatively new type of sensor that operates in the infrared. Adaptive Driver Assistance Systems (also referred to as ADAS) create a host of light management issues for designers. ADAS can include various passive and active sensors and cameras which all need to function based on light passing through and/or reflecting back through the laminate (such as the windshield). Each ADAS component operates within a unique wavelength or range of wavelengths within the EMI spectrum. The functional range could be within any of the UV, visible and/or near infrared (NIR) regions. The ADAS can also work in conjunction with head-up display (HUD) systems in a vehicle.

There is often a different polymer material in the area of the sensors. This may be referred to as a ‘cut out’ or a ‘patch’. In some windshields, the material in the area of the sensor(s) may be the same, but in some cases, such as when a different level of visible or infrared light transmission is necessary in the sensor area, there is a need to have a different material. For example, a windshield may have a high loading of solar absorber to provide a certain level of solar absorption capability to the windshield, but the light transmission level with the high loading of solar absorbing material may be too low for the sensor(s) to perform properly. In some cases, when the laminated glass is first produced, the sensor may function properly as the transmission level may be above the minimum necessary for the sensor to function, but over time, solar absorbing materials, such as solar absorbing interlayers comprising solar absorbers like cesium tungsten oxide, tend to darken over time (sometimes referred to as photodarkening or photochromic darkening), effectively reducing the light transmission, which could cause the sensor to function improperly due to the low visible light transmission. In some applications, a very high solar loading is necessary, such as in vehicles where high levels of heat absorption and/or reflection are needed. This is particularly important in vehicles with large windows, sunroofs, and the like, as well as in electric vehicles. Therefore a different material may be needed that will not darken over time to allow the sensor to function.

In some windshields, there are two or more (multiple) sensors. Each sensor may require different properties, such as light transmission level. For example, a windshield having a sensor such as a Light Detecting and Range (LIDAR) sensor may require high optical transparency and light transmission, so a polymer interlayer having the capability to allow high levels of light (such as greater than 90% at specific wavelengths) to pass through the glass may be desirable. For other sensors, which may be positioned in the same general area of the windshield, there may be different requirements. For example, there may be a rain sensor to determine whether or not to activate the windshield wipers and the appropriate wiper speed for the level of rain or precipitation. The rain sensor may require a certain optical transparency that is different from the optical transparency of the first sensor (i.e., a LIDAR sensor). Therefore, using the same polymer material used for one patch may not provide the required properties, such as light transmission, for the second (or subsequent) patch area.

Summarized, it is now common to have high performance laminates having one or more sensors which may have different functionality. The sensors may also have different requirements, such as a need for different visible transmission in order to properly operate or function. There is a need in the art for the development of a multiple layer glass panel or laminate that has good optical characteristics desirable in a multiple layer glass panel as well as excellent sensor compatibility with one or more sensors.

### SUMMARY OF THE INVENTION

Because of these and other problems in the art, described herein, among other things are a multiple layer panel or laminated glazing comprising: a first rigid substrate, a first polymer interlayer, and a second rigid substrate, wherein the multiple layer panel has a sensor area for at least a first sensor and a second sensor, and wherein the first polymer interlayer has a solar absorbing capability having a first visible light transmission, wherein the first sensor area comprises a second polymer interlayer selected to allow a first optically transparent area in the first sensor area, wherein the first optically transparent area has a second light transmission selected to allow a first sensor to operate, and wherein the second sensor area comprises a third polymer interlayer selected to allow a second optically transparent area in the second sensor area, wherein the second optically transparent area has a third light transmission selected to allow a second sensor to operate, wherein first polymer interlayer, the second polymer interlayer and the third polymer interlayer are different as further described below.

In one aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability having a first light transmission of less than 90% at about 905 nm, wherein the first sensor area comprises a second polymer interlayer selected to allow a first optically transparent area in the first sensor area, wherein the first optically transparent area has a second light transmission of greater than 90% at about 905 nm, and wherein the second sensor area comprises a third polymer interlayer selected to allow a second optically transparent area in the second sensor area, wherein the second optically transparent area has a third light transmission of greater than about 16% and less than about 85% at about 850 nm, wherein first polymer interlayer, the second polymer interlayer and the third polymer interlayer are different.

In another aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability with a first visible light transmission of less than 90% at about 905 nm, wherein the first sensor area comprises a second polymer interlayer selected to allow a first optically transparent area in the first sensor area, wherein the first optically transparent area has a second light transmission of greater than 90% at about 905 nm, and wherein the second sensor area comprises a coating on at least one of the first rigid substrate, the second rigid substrate and/or the second polymer interlayer selected to allow a second optically transparent area in the second sensor area, wherein the second optically transparent area has a third light transmission of greater than about 16% and less than about 85% at about 850 nm, wherein first polymer interlayer and the second polymer interlayer are different.

In another aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability with a first visible light transmission of less than 90% at about 905 nm, wherein the first sensor area comprises a second polymer interlayer selected to allow a first optically transparent area in the first sensor area, wherein the first optically transparent area has a second visible light transmission of greater than 90% at about 905 nm, and wherein the second sensor area comprises a pattern on at least one of the first rigid substrate, the second rigid substrate and/or the second polymer interlayer selected to allow a second optically transparent area in the second sensor area, wherein the second optically transparent area has a third visible light transmission of greater than about 16% and less than about 85% at about 850 nm, wherein first polymer interlayer and the second polymer interlayer are different.

In another aspect, In one aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability having a first light transmission of less than 90% at about 905 nm, wherein the first sensor area comprises a second polymer interlayer selected to allow a first optically transparent area in the first sensor area, wherein the first optically transparent area has a second light transmission of greater than 90% at about 905 nm, and wherein the second sensor area comprises a third polymer interlayer having pigments, dyes or other additives selected to allow a second optically transparent area in the second sensor area, wherein the second optically transparent area has a third light transmission of greater than about 16% and less than about 85% at about 850 nm, wherein first polymer interlayer, the second polymer interlayer and the third polymer interlayer are different.

Methods of making a multiple layer panel is also disclosed.

In embodiments, the multiple layer panel or laminated glazing is a windshield in a vehicle. In embodiments, the laminated glazing is used in a head-up display application.

In certain embodiments, the rigid substrate (or substrates) is glass. In embodiments, the glass is low iron glass or ultra-clear glass.

### BRIEF DESCRIPTION OF THE DRAWINGS

FIG. 1 is view of a windshield showing the area where sensors are mounted.

FIG. 2a is a close up view of a rain sensor area of a windshield that has a coating.

FIG. 2b is a close view up of a rain sensor area of a windshield that is patterned.

FIG. 3 is a view of an interlayer blank showing the sensor area where a cut out would be.

FIG. 4 is a view of an interlayer blank showing the sensor area for two sensors where two different cut outs would be.

### DESCRIPTION OF THE PREFERRED EMBODIMENT(S)

Described herein, among other things, are multiple layer panels or laminated glazings comprised of a first and second rigid substrate and a polymer interlayer. The laminated glazings of the present disclosure have improved compatibility with various sensors.

In a laminated glazing such as a windshield, particularly a windshield for an electric vehicle, it is desirable to have excellent solar absorbing capabilities in the laminated glazing(s). It is also desirable to have multiple sensors in the laminated glazing for different functionalities. Different sensors have different requirements in order to function. For example, some sensors, such as a LIDAR sensor, need to maintain a visible transmittance level (also referred to as visible light transmission) of at least 90% or more at about 905 nm. Other sensors require different ranges, such as a rain sensor, which needs to maintain a certain visible light transmission (% T) of greater than 16% and less than 85% at about 850 nm. Still other sensors require different levels of visible transmittance.

In a laminated glazing having high solar absorbing capability, the LIDAR sensor does not properly operate because the visible light transmittance is too low. A patch, such as a clear polymer having no solar absorbing material or capability, can be used to provide the required level of visible light transmittance. But if a second (or third or more) sensor is also used in the same area of the laminated glazing, the visible light transmittance of either the patch material used for the first sensor (i.e., the clear polymer), or of the solar absorbing polymer, may not be appropriate for the sensor. For example, while a certain solar absorbing material may start out at the right level of visible light transmittance, for example, where the rain sensor is placed on a laminated glazing, over time and due to exposure to the sun or other UV rays, the level of visible light transmittance may change (or lower) due to photodarkening of the polymer and the sensor may not function. Alternatively, if a clear patch is used to allow for very high visible transmission for some sensors, like LIDAR sensors which require greater than 90% visible light transmission at 905 nm, the visible light transmission level is too high for certain sensors, like a rain sensor. The inventor has discovered a way to solve the problem as described below.

In multiple layer panels, such as windshields, it has become common to use a patch or piece of material when a different functionality or property is desired. A windshield is often constructed by placing a polymer interlayer between two pieces of glass. The polymer interlayer is sometimes referred to as a windshield ‘blank’, and this blank is often cut from a roll of the polymer material. In the past, there has been a need at times to remove the polymer interlayer in one or more sections of the windshield (thereby making a cut out). Sometimes, the section that has been removed is replaced with a piece of a different polymer material that is cut to the same size and shape as the cut out section. The patch is placed where the cut out has been removed.

To achieve the desired optical transparency and other required properties in multiple areas of a laminated glazing or for multiple sensors, such as a LIDAR sensor and a rain sensor, two or more different polymer interlayers may be used as patches to provide different properties to the sections of the laminated glazing. For example, a ‘patch’ or piece of a polymer material different from the main polymer (or material in the majority of the laminated glazing) and/or another patch may be used in one or more sections to provide different properties. The first polymer interlayer may provide a first visible light transmittance value, and the second polymer interlayer may provide a second visible light transmittance value.

Depending on the specific type of interlayer and/or interlayer patches used, the interlayer and/or the patches may have a degree of instability following extended exposure to intense solar radiation. Solar or color additives within the interlayer may fade over time and exposure to become either lighter or darker, which may result in higher or lower transmission levels than the original state. These changes must be factored when considering the specific composition of the interlayer patches.

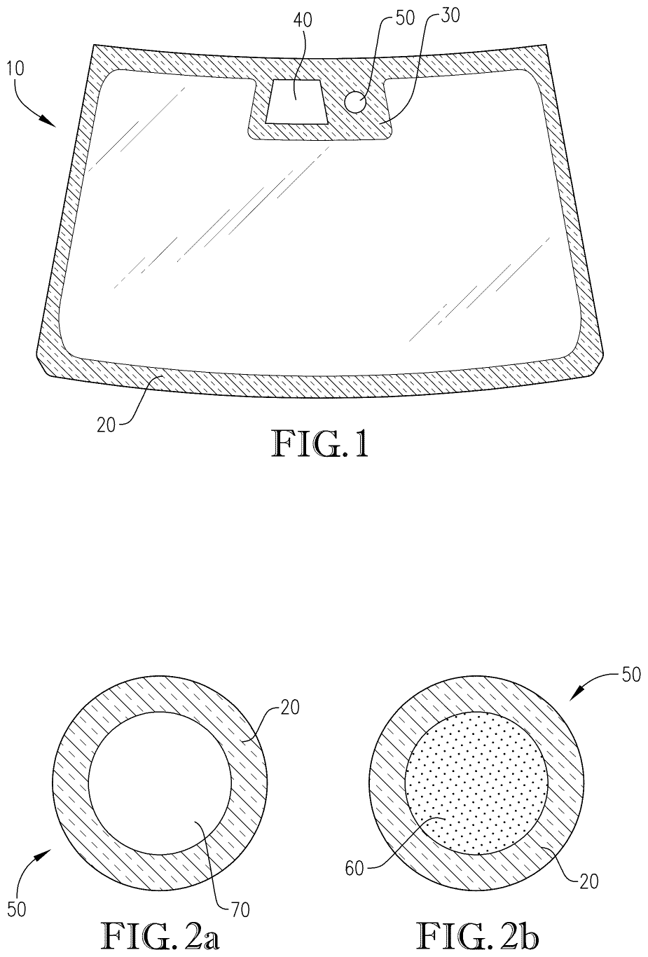

FIG. 1 shows a view of a windshield 10 showing the area where sensors, such as a LIDAR sensor and rain sensor may be located. In FIG. 1, there is a dark or black coating or frit 20 around the outside of the windshield. This frit 20 continues to the sensor area 30. In the sensor area 30, in the example shown, there are cut outs or areas for two different sensors. There is a first, larger sensor area 40 where a sensor such as a LIDAR sensor may be positioned, and a second, smaller sensor area 50 where a rain sensor or other sensor may be positioned.

FIGS. 2a and 2b show close up views of the smaller sensor area 50. Each of the sensor areas 50 have the frit 20 around the sensor area opening. In FIG. 2 a, the sensor area opening is shown as 70 and is a coated glass (coating not shown). In FIG. 2 b, the sensor area opening is shown as 60 and is a pattern.

In an alternative embodiment, a coating or pattern (as shown in FIGS. 2a and 2b) on one or more of the rigid substrates (i.e., glass) may be used to adjust the visible light transmittance value to the appropriate level, therefore allowing only one patch of a single polymer interlayer to be used instead of multiple patches. The coating or pattern is selected to change the light transmission value in a specific wavelength range to the desired range, such as reducing it to between 16% and 85% visible light transmission at about 850 nm for certain applications, such as a rain sensor. Different ranges and wavelengths may be selected depending on the sensor(s) and the application. The coating and/or pattern may be applied to the rigid substrate, to a film layer (such as a PET layer) included in or with the interlayer, or to the interlayer directly using any method known to one skilled in the art. For example, the coating may be applied to the interlayer using a layer by layer (LbL) technology to apply multiple layers to achieve the desired color and/or visible transmittance level. Alternatively, the coating may be applied to the rigid substrate by any method known to one skilled in the art. Examples of methods of applying a coating on a rigid substrate, an interlayer or a PET film include but not limited to rotogravure, flexo, and digital printing processes. Examples of coatings and patterned print on glass used in automotive applications typically contain ceramic frit coatings. The ceramic frit is baked into the glass using high temperature.

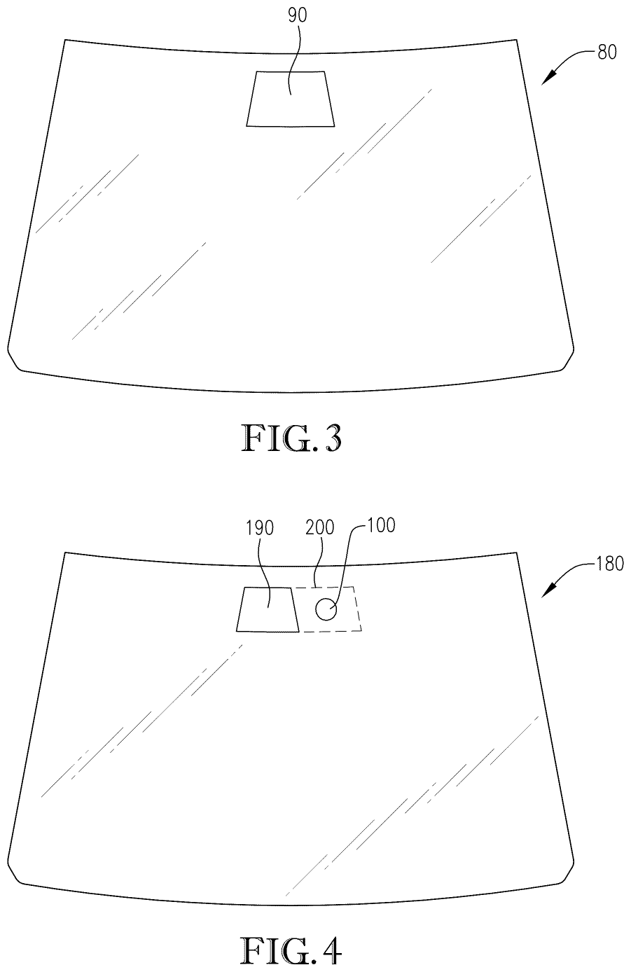

FIG. 3 shows an example of an interlayer blank 80 having a cut out 90 in the section where one or more sensors would be located. A patch of material fills the cut out section. FIG. 4 is another example of an interlayer blank 180 showing a sensor section 200 where two sensors would be located having a first cut out 190 for a first patch and a second cut out 100 for a second patch of a different material.

The polymer interlayer (including any patch) can be a single layer or multilayer polymer interlayer, and the interlayer (or any of the layers) can be made by mixing one or more polymer resins such as poly(vinyl acetal) resin (such as PVB) and one or more plasticizers. The multilayer interlayer generally contains two or more layers and two or more resins of different compositions. For example, poly(vinyl acetal) resins, such as PVB resins, of different residual hydroxyl contents and/or residual acetate contents are suitable for the layers of the multilayered interlayer compositions. In multilayer comprising two layers, at least one of the two layers is a soft layer and the other layer is a stiff layer. As used herein, a “soft layer” or “softer layer” is the layer having a glass transition temperature less than about 20° C. As used herein, a “stiff layer” or “stiffer layer” generally refers to a layer that is stiffer or more rigid than another layer and that has a glass transition temperature that is generally at least two degrees C (2° C.) higher than another layer (such as the softer layer).

The multilayer interlayers formed from the compositions contain two or more glass transitions, and the lowest glass transition occurs at less than 20° C., or less than 15° C., or less than 10° C., or less than 5° C., or less than 0° C., or less than −5° C., or less than-10° C.

Conventional multilayer interlayers such as a trilayer acoustic interlayer contain a soft core layer consisting of a single poly(vinyl butyral) (“PVB”) resin having a low residual hydroxyl content and a high amount of a conventional plasticizer, and two stiff skin layers having significantly higher residual hydroxyl content (see, for example U.S. Pat. Nos. 5,340,654, 5,190,826, and 7,510,771). The residual hydroxyl content in the PVB core resin and the amount of the plasticizer are optimized such that the interlayer provides optimal sound insulation properties under ambient conditions for multiple layer glass panels such as windshields and windows installed in vehicles and buildings.

Multilayer acoustic interlayers such as a trilayer can now be designed and produced by: (1) selecting a plasticizer or a mixture of plasticizers, (2) selecting resin(s) for the skin layer(s) and the core layer(s), (3) maintaining plasticizer equilibrium between the core layer(s) and the skin layer(s) (such as by selecting resins having particular properties), and (4) combining the core layer(s) and skin layer(s) to form multilayer interlayers by applicable processes such as co-extrusion or lamination. The resultant multilayer acoustic interlayer provides excellent clarity and sound insulation properties without sacrificing other favorable and desired characteristics of conventional multilayered interlayers, for example, optical properties, and mechanical strength of the glass panels made with the multilayered acoustic interlayer.

Some terminology as well as common components found in an interlayer, both generally and in interlayers of the present disclosure, and the formation thereof, will be discussed. The terms “polymer interlayer sheet,” “interlayer,” and “polymer melt sheet” as used herein, generally may designate a single-layer sheet or a multilayered interlayer. A “single-layer sheet,” as the name implies, is a single polymer layer extruded as one layer. A multilayered interlayer, on the other hand, may comprise multiple layers, including separately extruded layers, co-extruded layers, or any combination of separately and co-extruded layers. Thus a multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of a single-layer sheet and a plural-layer sheet; and a combination of at least one plural-layer sheet and at least one co-extruded sheet. In various embodiments of the present disclosure, a multilayered interlayer comprises at least two polymer layers (e.g., a single layer or multiple layers co-extruded and/or laminated together) disposed in direct contact with each other, wherein each layer comprises a polymer resin, as detailed more fully below. As used herein for multilayer interlayers having at least three layers, “skin layer” generally refers to the outer layers of the interlayer and “core layer” generally refers to the inner layer(s). Thus, one exemplary embodiment would be: skin layer//core layer//skin layer. In the multilayer interlayers having skin layer//core layer//skin layer configuration, in some embodiments the skin layer maybe stiffer and the core layer may be softer, while in other embodiments the skin layer may be softer and the core layer may be stiffer.

The poly(vinyl acetal) resin is produced by known acetalization processes by reacting polyvinyl alcohol (“PVOH”) with one or more aldehydes such as butyraldehyde in the presence of an acid catalyst, separation, stabilization, and drying of the resin. Such acetalization processes are disclosed, for example, in U.S. Pat. Nos. 2,282,057 and 2,282,026 and Wade, B. 2016, Vinyl Acetal Polymers, Encyclopedia of Polymer Science and Technology. 1-22 (online, copyright 2016 John Wiley & Sons, Inc.), the entire disclosures of which are incorporated herein by reference. The resin is commercially available in various forms, for example, as Butvar® Resin from Solutia Inc., a wholly owned subsidiary of Eastman Chemical Company.

As used herein, residual hydroxyl content (calculated as % vinyl alcohol or % PVOH by weight) in poly(vinyl acetal) resin refers to the amount of hydroxyl groups remaining on the polymer chains after processing is complete. For example, PVB can be manufactured by hydrolyzing poly(vinyl acetate) to poly(vinyl alcohol (PVOH), and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished PVB resin, there typically will be residual acetate groups (as vinyl acetate groups) and residual hydroxyl groups (as vinyl hydroxyl groups) as side groups on the polymer chain. As used herein, residual acetate content (calculated as % vinyl acetate content or poly(vinyl acetate) (PVAc) by weight in poly(vinyl acetal) refers to the amount of residual groups remaining on the polymer chains. As used herein, residual hydroxyl content and residual acetate content is measured on a weight percent (wt. %) basis per ASTM D1396.

In embodiments, when multilayer interlayer of the present invention is a trilayer, the core layer is the soft layer and the skin layers are the stiff layers. In other embodiments, the core layer is stiff and the skin layers are softer. Other combinations and numbers of layers are also possible.

In various embodiments, where the interlayer is a multilayer interlayer such as a trilayer, the soft (or core) layer comprises a poly(vinyl acetal) resin (or the first resin) comprising about 7 to about 16 weight percent (wt. %) hydroxyl groups calculated as % PVOH, about 7 to about 14 wt. %, about 9 to about 14 wt. %, about 8.5 to about 12 wt. %, and for certain embodiments, about 11 to about 13 wt. % hydroxyl groups calculated as % PVOH, although other amounts are also possible. The resin can also comprise less than 30 wt. % residual acetate groups, less than 25 wt. % residual acetate groups, less than 20 wt. %, less than 15 wt. %, less than 13 wt. %, less than 10 wt. %, less than 7 wt. %, less than 5 wt. %, or less than 1 wt. %, or less than 0.5 wt. % residual acetate groups calculated as poly(vinyl acetate), or in the range of from 0 to 30 wt. %, 1 to 30 wt. %, 2 to 25 wt. %, 5 to 20 wt. %, or 7 to 15 wt. % residual acetate groups, with the balance being an acetal, such as butyraldehyde (which includes isobutyraldehyde acetal groups), but optionally another acetal group, such as a 2-ethyl hexanal acetal group, or a mix of butyraldehyde acetal and 2-ethyl hexanal acetal groups.

In various embodiments, where the interlayer is a multilayer interlayer such as a trilayer, the stiff (or skin) layer(s) comprises a poly(vinyl acetal) resin having a residual hydroxyl of at least 2 wt. %, or at least 3, 4, 5, 6, 7, 8, 9, 10, 11, 12, 13, 14, 15, 16, 17, 18, 19 or 20 wt. % or more greater than the residual hydroxyl content of the resin in the soft (or core) layer, and the resin in the skin layer can comprise about 15 to about 35 wt. %, about 15 to about 30 wt. %, or about 17 to about 22 wt. %; and, for certain embodiments, about 17.25 to about 22.25 wt. % residual hydroxyl groups calculated as % PVOH, although other amounts are also possible depending on the desired properties.

This difference between the poly(vinyl acetal) resins is calculated by subtracting the residual hydroxyl content of the resin with the lower residual hydroxyl content from the residual hydroxyl content of the resin with the greater residual hydroxyl content. As used herein, the term “weight percent different” or “the difference . . . is at least . . . weight percent” refers to a difference between two given weight percentages, calculated by subtracting the one number from the other. For example, a poly(vinyl acetal) resin having a residual hydroxyl content of 12 weight percent has a residual hydroxyl content that is 2 weight percent lower than a poly(vinyl acetal) resin having a residual hydroxyl content of 14 weight percent (14 weight percent−12 weight percent=2 weight percent). As used herein, the term “different” can refer to a value that is higher than or lower than another value. One or more other poly(vinyl acetal) layers may also be present in the interlayer and can have a residual hydroxyl within the ranges provided above. Additionally, the residual hydroxyl content of the one or more other poly(vinyl acetal) resins can be the same as or different than the residual hydroxyl content of the first and/or second poly(vinyl acetal) resins.

In various embodiments, the poly(vinyl acetal) resin for the soft layer or the poly(vinyl acetal) resin for the stiff layer(s) can also comprise less than 30 wt. % residual acetate groups, less than 25 wt. % residual acetate groups, less than 20 wt. %, less than 15 wt. %, less than 13 wt. %, less than 10 wt. %, less than 7 wt. %, less than 5 wt. %, or less than 1 wt. % residual acetate groups calculated as poly(vinyl acetate), with the balance being an acetal, such as butyraldehyde (which includes isobutyraldehyde acetal groups), but optionally another acetal group, such as a 2-ethyl hexanal acetal group, or a mix of butyraldehyde acetal and 2-ethyl hexanal acetal groups, as previously discussed.

In some embodiments, the first and second poly(vinyl acetal) resins can have different residual acetate contents. For example, in some embodiments, the difference between the residual acetate content of the first and second poly(vinyl acetal) resins can be at least about 2, at least about 3, at least about 4, at least about 5, at least about 6, at least about 7, at least about 8, at least about 9, at least about 10, at least about 12, at least about 14, at least about 16, at least about 18, at least about 20, at least about 24, or at least 29 weight percent. One of the poly(vinyl acetal) resins may have a residual acetate content of not more than about 4, not more than about 3, not more than about 2, or not more than about 1 weight percent, measured as described above. In some embodiments, one of the first and second poly(vinyl acetal) resins can have a residual acetate content of at least 4, at least about 5, at least about 6, at least about 7, about 8, at least about 10, at least about 12, at least about 14, at least about 16, at least about 18, at least about 20, at least about 25, or at least about 30 weight percent. In other embodiments, the first and second poly(vinyl acetate) resins both can have a residual acetate content of at least 4, at least about 5, at least about 6, at least about 7, about 8, at least about 10, at least about 12, at least about 14, at least about 16, at least about 18, at least about 20 weight percent. The difference in the residual acetate content between the first and second poly(vinyl acetal) resins can be within the ranges provided above, or the difference can be less than about 3, not more than about 2, not more than about 1, or not more than about 0.5 weight percent. Additional poly(vinyl acetal) layers present in the interlayer can have a residual acetate content the same as or different from the residual acetate content of the first and/or second poly(vinyl acetal) resin.

The poly(vinyl acetal) resin such as poly(vinyl butyral) (PVB) resin (or resins) of the present disclosure typically has a molecular weight of greater than 50,000 Daltons, or less than 500,000 Daltons, or about 50,000 to about 500,000 Daltons, or about 70,000 to about 500,000 Daltons, or about 100,000 to about 425,000 Daltons, as measured by size exclusion chromatography using a low angle laser light scattering detector, a differential refractometer or a UV detector. As used herein, the term “molecular weight” means the weight average molecular weight.

Various adhesion control agents (“ACAs”) can be used in the interlayers of the present disclosure to control the adhesion of the interlayer sheet to glass. In various embodiments of interlayers of the present disclosure, the interlayer can comprise about 0.003 to about 0.15 parts ACAs per 100 parts resin; about 0.01 to about 0.10 parts ACAs per 100 parts resin; and about 0.01 to about 0.04 parts ACAs per 100 parts resin. Such ACAs, include, but are not limited to, the ACAs disclosed in U.S. Pat. No. 5,728,472 (the entire disclosure of which is incorporated herein by reference), sodium acetate, potassium acetate, magnesium bis(2-ethyl butyrate), and/or magnesium bis(2-ethylhexanoate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, among other additives known to those of ordinary skill in the art.

In various embodiments, the plasticizer may be selected from high refractive index plasticizers, a mixture of two or more high refractive index plasticizers, or a mixture of a conventional plasticizer and one or more high refractive index plasticizer(s).

As used herein, plasticizer having a refractive index of about 1.450 or less is referred to as a “conventional plasticizer”. Conventional plasticizers include, but are not limited to, triethylene glycol di-(2-ethylhexanoate) (“3GEH”), triethylene glycol di-(2-ethylbutyrate), triethylene glycol diheptanoate, tetraethylene glycol diheptanoate, tetraethylene glycol di-(2-ethylhexanoate), dihexyl adipate, dioctyl adipate, hexyl cyclohexyladipate, diisononyl adipate, heptylnonyl adipate, di(butoxyethyl) adipate, and bis(2-(2-butoxyethoxy)ethyl) adipate, dibutyl sebacate, dioctyl sebacate, and mixtures thereof. These plasticizers have refractive indices of about 1.442 to about 1.449. In comparison, PVB resin has a refractive index of approximately 1.485 to 1.495. In interlayers manufactured for various properties and applications, 3GEH (refractive index=1.442) is one of the most common plasticizers present.

In various embodiments, one or more high refractive index plasticizer(s) may be used. In embodiments, the high refractive index plasticizer(s) is selected such that the refractive index of the plasticizer is at least about 1.460, or greater than about 1.460, or greater than about 1.470, or greater than about 1.480, or greater than about 1.490, or greater than about 1.500, or greater than 1.510, or greater than 1.520, for both the core and/or skin layers. As used herein, a “high refractive index plasticizer” is a plasticizer having a refractive index of at least about 1.460. In some embodiments, the high refractive index plasticizer(s) is used in conjunction with a conventional plasticizer, and in some embodiments, if included, the conventional plasticizer is triethylene glycol di-(2-ethylhexanoate) (“3GEH”), and the refractive index of the plasticizer mixture is at least 1.460. As used herein, the refractive index of a plasticizer or a resin used in the entirety of this disclosure is either measured in accordance with ASTM D542 at a wavelength of 589 nm and 25° C. or as reported in literature in accordance with the ASTM D542.

Examples of plasticizers having a high refractive index that may be used include, but are not limited to, polyadipates (RI of about 1.460 to about 1.485); epoxides (RI of about 1.460 to about 1.480); phthalates and terephthalates (RI of about 1.480 to about 1.540); benzoates (RI of about 1.480 to about 1.550); and other specialty plasticizers (RI of about 1.490 to about 1.520). Specific examples of suitable high refractive index plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, bis-phenol A bis(2-ethylhexaonate), ethoxylated nonylphenol, nonylphenyl tetraethylene glycol, dioctyl phthalate, diisononyl phthalate, di-2-ethylhexyl terephthalate, mixtures of benzoic acid esters of dipropylene glycol and diethylene glycol, and mixtures thereof.

The total plasticizer content in the interlayer can be from 0 to 120 phr, or greater than 0 phr, or greater than 5 phr, or greater than 10 phr, or greater than 15 phr, or greater than 20 phr, or greater than 25 phr, or greater than 30 phr and/or 120 phr or less, or 115 phr or less, or 110 phr or less, or 105 phr or less, or 100 phr or less, or 95 phr or less, or 90 phr or less, or 85 phr or less, or 80 phr or less, or 75 phr or less, or 70 phr or less, or within the range of 10 to 100 phr, or 20 to 80 phr, or 30 to 70 phr. In various embodiments of interlayers of the present disclosure, the interlayer comprises greater than 5 phr, about 5 to about 120 phr, about 10 to about 90 phr, about 20 to about 70 phr, about 30 to about 60 phr, or less than 120 phr, or less than 90 phr, or less than 60 phr, or less than 40 phr, or less than 30 phr total plasticizer. While the total plasticizer content is indicated above, the plasticizer content in the skin layer(s) or core layer(s) can be different from the total plasticizer content. In addition, the skin layer(s) and core layer(s) can have different plasticizer types and plasticizer contents, in the ranges previously discussed, as each respective layer's plasticizer content at the equilibrium state is determined by the layer's respective residual hydroxyl contents, as disclosed in U.S. Pat. No. 7,510,771 (the entire disclosure of which is incorporated herein by reference). For example, at equilibrium the interlayer could comprise two skin layers, each with 30 phr plasticizer, and a core layer with 65 phr plasticizer, for a total plasticizer amount for the interlayer of about 45.4 phr when the combined skin layer thickness equals that of the core layer. For thicker or thinner skin layers, the total plasticizer amount for the interlayer would change accordingly. As used herein, when the plasticizer content of the interlayer is given, the plasticizer content is determined with reference to the phr of the plasticizer in the mix or melt that was used to produce the interlayer.

The amount of plasticizer in the interlayer can be adjusted to affect the glass transition temperature (T_{g}) and the final acoustic performance of the interlayer. The glass transition temperature (T_{g}) is the temperature that marks the transition from the glassy state of the interlayer to the rubbery state. In general, higher amounts of plasticizer loading will result in lower T_{g}. Conventional, previously utilized interlayers generally have had a T_{g} in the range of about −10 to 25° C. for acoustic (noise reducing) interlayers, and up to about 45° C. for hurricane and aircraft (stiffer or structural) interlayer applications. The glass transition temperature (T_{g}) can be determined by dynamical mechanical thermal analysis (DMTA) in shear mode. The DMTA measures the storage (elastic) modulus (G′) in Pascals, loss (viscous) modulus (G″) in Pascals, tan delta (=G″/G′) of the specimen as a function of temperature at a given frequency, and temperature sweep rate. A frequency of 1 Hz and temperature sweep rate of 3° C./min were used herein. The T_{g} is then determined by the position of the tan delta peak on the temperature scale in ° C. and the tan delta peak value is referred as tan delta or peak tan delta. As used herein, “tan delta”, “peak tan delta”, “tan δ” and “peak tan δ” may be used interchangeably.

An interlayer's glass transition temperature (T_{g}) is also correlated with the stiffness of the interlayer, and in general, the higher the glass transition temperature, the stiffer the interlayer. Generally, an interlayer with a glass transition temperature of 30° C. or higher increases windshield mechanical strength and torsional rigidity. A soft layer or interlayer (generally characterized by a layer or interlayer with a glass transition temperature of lower than 20° C.), on the other hand, contributes to the sound dampening effect (i.e., the acoustic characteristics). The interlayers of the present disclosure may have glass transition temperatures of about 26° C. or greater, or about 35° C. or greater for the stiffer layer(s), and about 20° C. or less, or 15° C. or less, or 10° C. or less, or about 5° C. or less, or 0° C. or less, or about −5° C. or less, or about −10° C. or less for the soft layer(s), although other glass transition temperatures are possible depending on the desired performance and properties.

In some embodiments, the multilayered interlayers of the present disclosure combine these two advantageous properties (i.e., strength and acoustic) by utilizing harder or stiffer skin layers laminated with a softer core layer (e.g., stiff//soft//stiff). In various embodiments, the multilayered interlayers generally comprise stiffer layer(s) comprising poly(vinyl acetal) resin(s) with a glass transition temperature of about 26° C. to about 60° C., about 26° C. to 40° C., about 26° C. or greater, about 30° C. or greater, or about 35° C. or greater, and softer layer(s) of about 20° C. or less, about 10° C. or less, or about 5° C. or less, or about 0° C. or less, or about −5° C. or less, or about −10° C. or less.

The final interlayer, whether formed from extrusion or co-extrusion or by lamination of multiple layers, generally has a random rough surface topography as it is formed through melt fractures of polymer melt as it exits the extrusion die and may additionally be embossed over the random rough surface on one or both sides (e.g., the skin layers) by any method of embossment known to one of ordinary skill in the art.

While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminates of the present invention are formed using lamination processes known in the art.

Generally, the thickness, or gauge, of the polymer interlayer sheet will be in a range from about 15 mils to 100 mils (about 0.38 mm to about 2.54 mm), about 15 mils to 60 mils (about 0.38 mm to about 1.52 mm), about 20 mils to about 50 mils (about 0.51 to 1.27 mm), and about 15 mils to about 35 mils (about 0.38 to about 0.89 mm). In various embodiments, each of the layers, such as the skin and core layers, of the multilayer interlayer may have a thickness of about 1 mil to 99 mils (about 0.025 to 2.51 mm), about 1 mil to 59 mils (about 0.025 to 1.50 mm), 1 mil to about 29 mils (about 0.025 to 0.74 mm), or about 2 mils to about 28 mils (about 0.05 to 0.71 mm), although other thicknesses may be selected depending on the desired performance and properties.

Although many of the embodiments described below refer to the polymer resin as being PVB, it would be understood by one of ordinary skill in the art that the polymer may be any polymer suitable for use in a multiple layer panel. Typical polymers include, but are not limited to, polyvinyl acetals (PVA) (such as poly(vinyl butyral) (PVB) or poly(vinyl isobutyral), an isomer of poly(vinyl butyral) and also referred as PVisoB, aliphatic polyurethane (PU), poly(ethylene-co-vinyl acetate) (EVA), polyvinylchloride (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and its ionomers, derived from any of the foregoing possible thermoplastic resins, combinations of the foregoing, and the like. PVB and its isomer polyvinyl isobutyral, polyvinyl chloride, ionomers, and polyurethane are suitable polymers generally for interlayers; PVB (including its isomer PVisoB) is particularly suitable.

Examples of exemplary multilayer interlayer constructs include, but are not limited to, PVB//PVisoB//PVB, where the PVisoB layer comprises two or more resins having different residual hydroxyl and/or residual acetate contents or different polymer compositions; PVC//PVB//PVC, PU//PVB//PU, Ionomer//PVB//Ionomer, Ionomer//PU//Ionomer, Ionomer//EVA//Ionomer, where the core layer PVB (including PVisoB), PU or EVA can comprise a single resin having one glass transitions or two or more resins having different glass transitions. Alternatively, the skin and core layers may all be PVB using the same or different starting resins, having the same or different residual hydroxyl and/or residual acetate contents, and the same or different plasticizers. Other combinations of resins and polymers will be apparent to those skilled in the art.

While generally referred to as poly(vinyl acetal) or poly(vinyl butyral), any of the poly(vinyl acetal) resins can include residues of any suitable aldehyde, such as isobutyraldehyde, as previously discussed. In some embodiments, one or more poly(vinyl acetal) resin can include residues of at least one C₁ to C₁₀ aldehyde, or at least one C₄ to C₈ aldehyde. Examples of suitable C₄ to C₈ aldehydes can include, but are not limited to, n-butyraldehyde, isobutyraldehyde, 2-methylvaleraldehyde, n-hexyl aldehyde, 2-ethylhexyl aldehyde, n-octyl aldehyde, and combinations thereof. At least one of the first and second poly(vinyl acetal) resins can include at least about 20, at least about 30, at least about 40, at least about 50, at least about 60, or at least about 70 weight percent of residues of at least one C₄ to C₈ aldehyde, based on the total weight of aldehyde residues of the resin, and/or can include not more than about 90, not more than about 85, not more than about 80, not more than about 75, not more than about 70, or not more than about 65 weight percent of at least one C₄ to C₈ aldehyde, or in the range of from about 20 to about 90, about 30 to about 80, or about 40 to about 70 weight percent of at least one C₄ to C₈ aldehyde. The C₄ to C₈ aldehyde may be selected from the group listed above, or it can be selected from the group consisting of n-butyraldehyde, isobutyraldehyde, 2-ethylhexyl aldehyde, and combinations thereof.

In various embodiments, one or more poly(vinyl acetal) resin may be a poly(vinyl butyral) (PVB) resin. In other embodiments, one or more poly(vinyl acetal) resin can be a poly(vinyl butyral) resin that mainly comprises residues of n-butyraldehyde, and may, for example, include not more than about 50, not more than about 40, not more than about 30, not more than about 20, not more than about 10, not more than about 5, or not more than about 2 weight percent of residues of an aldehyde other than butyraldehyde, based on the total weight of all aldehyde residues of the resin.

As used herein, a multiple layer panel can comprise a single substrate, such as glass, acrylic, or polycarbonate (or other rigid substrate) with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, in that polymer films do not themselves provide the necessary penetration resistance and glass retention properties, but rather provide performance improvements, such as infrared absorption characteristics. Poly(ethylene terephthalate) (“PET”) is the most commonly used polymer film. Generally, as used herein, a polymer film is thinner than a polymer sheet, such as from about 0.001 to 0.2 mm thick, although other thicknesses may be used.

The multiple layer panels, such as windshields, described herein will generally comprise two substrates, such as a pair of glass sheets (or other rigid materials, such as polycarbonate or acrylic, known in the art), with the interlayer(s) disposed between the two substrates. An example of such a construct would be: (glass)//(polymer interlayer sheet)//(glass), where the polymer interlayer sheet can comprise multilayered interlayers, as noted above, and can have one or more patches or sections of different polymer material. These examples of multiple layer panels are in no way meant to be limiting, as one of ordinary skill in the art would readily recognize that numerous constructs other than those described above could be made with the interlayers of the present disclosure.

The typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperatures between about 135° C. and 150° C. and pressures between about 180 psig and 200 psig for about 30 to 90 minutes. The actual steps, as well as the times and temperatures, may vary as necessary, as known by one skilled in the art.

A cut out and patch process can be applied to modify a specific area(s) of the interlayer in order to provide different or specific performance attributes. These attributes can include, but are not limited to, modification of the UV, visible, and NIR regions of the EMI spectrum. Cut outs can be any shape and size and can be applied within any area(s) within the entire interlayer. One cut out or multiple cut outs can be used to affect different areas of the interlayer. Patches normally need to consist of interlayers with similar thickness and thickness profile, and patches can possess similar attributes or possess very different attributes from the interlayer being patched. A cut out is an area of the interlayer which is removed from the interlayer by some form of cutting tool, such as by a punch device (if multiple cut outs are being used in a repetitive process). The patch is comprised of a nearly identical size, shape, and thickness interlayer as the interlayer being patched, but generally will have some difference, such as a different composition, additives and/or functionality. The patch is then inserted in the location of the cut out in the original interlayer. Lamination is then performed according to the same standard laminating practices described above and known to one of skill in the art.

Other means for use in de-airing of the interlayer-glass interfaces (steps 2 to 5) known in the art and that are commercially practiced include vacuum bag and vacuum ring processes in which a vacuum is utilized to remove the air.

The invention also includes the following aspects, set forth below.

In one aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability having a first visible light transmission, wherein the first sensor area comprises a second polymer interlayer selected to allow a first optically transparent area in the first sensor area, wherein the first optically transparent area has a second light transmission selected to allow a first sensor to operate, and wherein the second sensor area comprises a third polymer interlayer selected to allow a second optically transparent area in the second sensor area, wherein the second optically transparent area has a third light transmission selected to allow a second sensor to operate, wherein first polymer interlayer, the second polymer interlayer and the third polymer interlayer are different.

In another aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability having a first light transmission of less than 90% at about 905 nm, wherein the first sensor area comprises a second polymer interlayer selected to allow a first optically transparent area in the first sensor area, wherein the first optically transparent area has a second light transmission of greater than 90% at about 905 nm, and wherein the second sensor area comprises a third polymer interlayer selected to allow a second optically transparent area in the second sensor area, wherein the second optically transparent area has a third light transmission of greater than about 16% and less than about 85% at about 850 nm, wherein first polymer interlayer, the second polymer interlayer and the third polymer interlayer are different.

In another aspect, the second polymer interlayer of any of the multiple layer panels is a clear polymer interlayer. In the multiple layer panel of any of the aspects, the third polymer interlayer is a colored polymer interlayer, and the colored polymer interlayer may have a color that is green, blue, grey, bronze, or a combination of green, blue, grey and bronze.

In another aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability with a first visible light transmission of less than 90% at about 905 nm, wherein the first sensor area comprises a second polymer interlayer selected to allow a first optically transparent area in the first sensor area, wherein the first optically transparent area has a second light transmission of greater than 90% at about 905 nm, and wherein the second sensor area comprises a coating on at least one of the first rigid substrate, the second rigid substrate and/or the second polymer interlayer selected to allow a second optically transparent area in the second sensor area, wherein the second optically transparent area has a third light transmission of greater than about 16% and less than about 85% at about 850 nm, wherein first polymer interlayer and the second polymer interlayer are different.

In another aspect, a multiple layer panel comprises: a first rigid substrate, a first polymer interlayer, and a second rigid substrate, wherein the multiple layer panel has a sensor area for at least a first sensor and a second sensor, and wherein the first polymer interlayer has a solar absorbing capability with a first visible light transmission of less than 90% at about 905 nm, wherein the first sensor area comprises a second polymer interlayer selected to allow a first optically transparent area in the first sensor area, wherein the first optically transparent area has a second visible light transmission of greater than 90% at about 905 nm, and wherein the second sensor area comprises a pattern on at least one of the first rigid substrate, the second rigid substrate and/or the second polymer interlayer selected to allow a second optically transparent area in the second sensor area, wherein the second optically transparent area has a third visible light transmission of greater than about 16% and less than about 85% at about 850 nm, wherein first polymer interlayer and the second polymer interlayer are different.

The multiple layer panel of any aspect may have first and second rigid substrates that are low iron or ultra-clear glass. The multiple layer panel of any aspect may be a windshield.

In another aspect, a method of making a multiple layer panel comprises the steps of: providing a first rigid substrate, providing a first polymer interlayer and placing the first polymer interlayer on the first rigid substrate, and providing a second rigid substrate, wherein the first polymer interlayer has a sensor area having a first sensor area and a second sensor area, and wherein the first polymer area has a solar absorbing capability with a first visible light transmission of less than 90% at about 905 nm, and wherein the first sensor area comprises a second polymer interlayer selected to allow a first optically transparent area in the first sensor area, wherein the first optically transparent area has a second visible light transmission of greater than 90% at about 905 nm, and wherein the second sensor area comprises a third polymer interlayer selected to allow a second optically transparent area in the second sensor area, wherein the second optically transparent area has a third visible light transmission of greater than about 16% and less than about 85% at about 850 nm, wherein the first polymer interlayer, the second polymer interlayer and the third polymer interlayer are different.

In any aspect of the method of making a multiple layer panel, the second polymer interlayer may be a clear polymer interlayer. The third polymer interlayer may be a colored polymer interlayer, and the colored polymer interlayer may have a color that is green, blue, grey, bronze, or a combination of green, blue, grey and bronze.

In another aspect, a method of making a multiple layer panel comprises the steps of: providing a first rigid substrate, providing a first polymer interlayer and placing the first polymer interlayer on the first rigid substrate, and providing a second rigid substrate, wherein the first polymer interlayer has a sensor area having a first sensor area and a second sensor area, and wherein the first polymer area has a solar absorbing capability with a first visible light transmission of less than 90% at about 905 nm, and wherein the first sensor area comprises a second polymer interlayer selected to allow a first optically transparent area in the first sensor area, wherein the first optically transparent area has a second visible light transmission of greater than 90% at about 905 nm, and wherein the second sensor area comprises a pattern on at least one of the first rigid substrate, the second rigid substrate and/or the second polymer interlayer selected to allow a second optically transparent area in the second sensor area, wherein the second optically transparent area has a third visible light transmission of greater than about 16% and less than about 85% at about 850 nm, and wherein the first polymer interlayer and the second polymer interlayer are different.

In another aspect, a method of making a multiple layer glass panel comprises the steps of: providing a first rigid substrate, providing a first polymer interlayer and placing the first polymer interlayer on the first rigid substrate, and providing a second rigid substrate, wherein the first polymer interlayer has a sensor area having a first sensor area and a second sensor area, and wherein the first polymer area has a solar absorbing capability with a first visible light transmission of less than 90% at about 905 nm, and wherein the first sensor area comprises a second polymer interlayer selected to allow a first optically transparent area in the first sensor area, wherein the first optically transparent area has a second visible light transmission of greater than 90% at about 905 nm, and wherein the second sensor area comprises a coating on at least one of the first rigid substrate, the second rigid substrate and/or the second polymer interlayer selected to allow a second optically transparent area in the second sensor area, wherein the second optically transparent area has a third visible light transmission of greater than about 16% and less than about 85% at about 850 nm, and wherein the first polymer interlayer and the second polymer interlayer are different.

In any aspect, the multiple layer panel made by the method described herein may have first and second rigid substrates that are low iron or ultra-clear glass. The multiple layer panel of any method described herein may be a windshield.

One aspect includes a multiple layer panel or laminated glazing that is a windshield for an automobile or other vehicle, and the laminated glazing or the windshield may be used for a head-up display application in a vehicle.

Other combinations of features are also included and contemplated as known to one skilled in the art.

### EXAMPLES

Examples of different multiple layer panel configurations and combinations of patches as well as patterns or coatings are provided below to illustrate the invention.

### Example 1

A multiple layer glass panel could be produced comprising two glass substrates and a polymer interlayer. The glass panel also may optionally have more than one polymer interlayer (or a multilayer interlayer), or one or more interlayer and one or more films, such as a PET film, for additional functionality. The glass substrates can comprise 2.3 mm thick ultra-clear glass containing very low iron content (such as commercially available Starphire® glass sold by Vitro). Low iron, or ultra-clear glass, contains an extremely low concentration of iron. Low iron glass provides nearly no color, and very high light transmission in the UV, visible, and NIR spectrum. Light transmission in glass substrates less than 6 mm thick are generally greater than about 90%.

The polymer interlayer used in the glass panel has solar capability (commercially available as Saflex® QXH1 0000S5 interlayer from Eastman Chemical Company which is a solar absorbing interlayer that provides solar functionality of about 74.9% visible transmission, 17.1% transmission at 850 nm, and 13.6% transmission at 905 nm when laminated. Prior to lamination, two areas of the polymer interlayer are cut out and different patches are inserted. The first patch is a clear polymer interlayer without solar functionality (Saflex® Clear PVB interlayer commercially available from Eastman Chemical Company), and the second patch is a grey polymer interlayer (Saflex® RB47 654400 PVB interlayer commercially available from Eastman Chemical Company). The visible light transmittance is then measured in each of the patch areas, and the results are as follows. The first patch area containing the clear interlayer provides 91% visible transmission, 88% transmission at 850 nm, and 90% transmission at 905 nm. The second patch area containing the grey interlayer would have about 46% visible transmission, about 64% transmission at 850 nm, and about 65% transmission at 905 nm.

LIDAR sensor areas will function with any patch interlayer that provides a transmission level of at least 90% at 905 nm, therefore using a clear interlayer would provide the required visible light transmission level necessary. A different sensor, such as a rain sensor, will function with any patch interlayer that provides a range of transmission range of at least 16% to about 85% at 850 to 880 nm, therefore using a pigmented or colored interlayer, such as a gray interlayer, effectively provides the required visible light transmission. The clear interlayer patch cannot be used for both sensor areas because the visible light transmission of the clear interlayer is too high and the rain sensor would not function.

### Example 2

A second panel could be constructed in the same way as the panel in Example 1 using 2.3 mm ultra-clear glass, a solar absorbing interlayer, and a clear patch and a second, different colored patch in the two sensor areas. The first patch area containing the clear interlayer provides about 91% visible transmission, 88% transmission at 850 nm, and 90% transmission at 905 nm. The second patch area containing a blue-green color patch (Saflex® RB47 377300 PVB interlayer commercially available from Eastman Chemical Company) would have a visible transmission of about 74%, about 78% transmission at 850 nm, and about 77% transmission at 905 nm.

As previously stated, LIDAR sensor areas will function with any patch interlayer that provides a transmission level of at least 90% at 905 nm, therefore using a clear interlayer would provide the required visible light transmission level necessary. A different sensor, such as a rain sensor, will function with any patch interlayer that provides a range of transmission range of at least 16% to about 85% at 850 to 880 nm, therefore using a pigmented or colored interlayer, such as a blue-green interlayer, effectively provides the required visible light transmission. The clear interlayer patch cannot be used for both sensor areas because the visible light transmission of the clear interlayer is too high and the rain sensor would not function.

### Example 3

A multiple layer glass panel could be produced comprising two glass substrates and a polymer interlayer. The glass substrates could comprise 2.3 mm thick ultra-clear glass containing very low iron content (such as commercially available Starphire® glass sold by Vitro). The polymer interlayer used in the glass panel has solar capability (commercially available as Saflex® QXH1 0000S5 interlayer from Eastman Chemical Company) which provides solar functionality of about 74.9% visible transmission, 17.1% transmission at 850 nm, and 13.6% transmission at 905 nm when laminated. Prior to lamination, one area of the polymer interlayer is cut out and a patch is inserted in the area where multiple sensors would be located. The patch is a clear polymer interlayer without solar functionality (Saflex® Clear PVB interlayer commercially available from Eastman Chemical Company). Instead of a second patch, a coating can be applied to one of the glass layers to reduce the transmission level to about 80% at 850 nm. The coating could be applied to any of the four interfacial surfaces, however the outermost surface (furthest from the sensor) may be found to be the least effective. The visible light transmittance is then measured in each of the areas (i.e., where the patch is applied and where the coating is applied, and the results would be as follows. The patch area containing clear interlayer provides about 91% visible transmission, 88% transmission at 850 nm, and 90% transmission at 905 nm. The patch area containing clear interlayer in combination with the area of coated glass (where a second sensor such as a rain sensor would be located) would have a visible transmission of about 75%, 75% transmission at 850 nm, and 80% transmission at 905 nm.

As previously stated, LIDAR sensor areas will function with any patch interlayer that provides a transmission level of at least 90% at 905 nm, therefore using a clear interlayer would provide the required visible light transmission level necessary. A different sensor, such as a rain sensor, will function as long as the optically transparent area has a visible light transmission in the appropriate range (of at least 16% to about 85% at 850 to 880 nm). By providing a coating to one (or more) layers of the panel (such as one of the glass substrates or to the interlayer directly), the visible light transmission can be reduced to the appropriate and required level. The clear interlayer patch cannot be used for both sensor areas without modification in the rain sensor (or other sensor) area because the visible light transmission of the clear interlayer is too high and the rain sensor would not function.

### Comparative Example 1

A Comparative Example of a multiple layer glass panel could be produced in the same manner as described previously. The glass substrates comprise 2.3 mm thick ultra-clear glass containing very low iron content (such as commercially available Starphire® glass sold by Vitro). The polymer interlayer used in the glass panel has solar capability (commercially available as Saflex® QXH1 0000S5 interlayer from Eastman Chemical Company) which provides solar functionality of about 74.9% visible transmission, 17.1% transmission at 850 nm, and 13.6% transmission at 905 nm when laminated. Only one patch is used in one sensor area (for example, where a LIDAR sensor or other sensor requiring high visible light transmission is located. The solar interlayer material is not cut out in the second sensor area. Prior to lamination, one area of the polymer interlayer is cut out and a patch is inserted where a sensor would be located, but not where the second sensor would be located (i.e., a rain sensor). The patch is a clear polymer interlayer without solar functionality (Saflex® Clear PVB interlayer commercially available from Eastman Chemical Company). In the area of the second sensor, where the solar absorbing interlayer is located, the original visible light transmission level is 17% at 850 nm, which is just acceptable for use with certain sensors, such as a rain sensor, which requires greater than 16% visible light transmission at 850 nm to operate. The laminate is then subjected to exposure to light, and the transmission at 850 nm of the solar absorbing interlayer decreases from 17% to 12% following 3,000 hours of xenon arc accelerated exposure testing (which is a similar level of solar irradiance that a windshield would receive due to exposure to the sun in two years). While the original visible light transmission of 17% at 850 nm initial transmission level prior to exposure is just adequate to allow rain sensor functionality, the 12% visible light transmission at 850 nm following exposure to the sun (or UV light) will render the rain sensor inoperable.

In conclusion, the laminated glazings, such as windshields for automobiles, comprising either multiple patches of different materials, or one or more patches and an either a pattern or coating on the glass in the sensor area have enhanced sensor compatibility. Other advantages will be readily apparent to those skilled in the art.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, an interlayer can be formed comprising poly(vinyl butyral) having a residual hydroxyl content in any of the ranges given in addition to comprising a plasticizers in any of the ranges given to form many permutations that are within the scope of the present disclosure, but that would be cumbersome to list. Further, ranges provided for a genus or a category, such as phthalates or benzoates, can also be applied to species within the genus or members of the category, such as dioctyl terephthalate, unless otherwise noted.

1. A multiple layer panel comprising:
a first rigid substrate,
a first polymer interlayer, and
a second rigid substrate,
wherein the multiple layer panel has a sensor area for at least a first sensor and a second sensor, and
wherein the first polymer interlayer has a solar absorbing capability having a first visible light transmission,
wherein the first sensor area comprises a second polymer interlayer selected to allow a first optically transparent area in the first sensor area, wherein the first optically transparent area has a second light transmission selected to allow a first sensor to operate, and
wherein the second sensor area comprises a third polymer interlayer selected to allow a second optically transparent area in the second sensor area, wherein the second optically transparent area has a third light transmission selected to allow a second sensor to operate,
wherein first polymer interlayer, the second polymer interlayer and the third polymer interlayer are different.

2. A multiple layer panel of claim 1 wherein the first polymer interlayer has a solar absorbing capability having a first light transmission of less than 90% at about 905 nm, and
wherein the first sensor area comprises a second polymer interlayer selected to allow a first optically transparent area in the first sensor area, wherein the first optically transparent area has a second light transmission of greater than 90% at about 905 nm, and
wherein the second sensor area comprises a third polymer interlayer selected to allow a second optically transparent area in the second sensor area, wherein the second optically transparent area has a third light transmission of greater than about 16% and less than about 85% at about 850 nm.

3. The multiple layer panel of claim 1, wherein the second polymer interlayer is a clear polymer interlayer.

4. The multiple layer panel of claim 3, wherein
the third polymer interlayer is a colored polymer interlayer.

5. The multiple layer panel of claim 4, wherein the third polymer interlayer is a colored polymer interlayer having a color that is green, blue, grey, bronze, or a combination of green, blue, grey and bronze.

6. A multiple layer panel of claim 1:
wherein the first polymer interlayer has a solar absorbing capability with a first visible light transmission of less than 90% at about 905 nm, and
wherein the first optically transparent area has a second light transmission of greater than 90% at about 905 nm, and
wherein the second sensor area comprises a coating on at least one of the first rigid substrate, the second rigid substrate and/or the second polymer interlayer selected to allow a second optically transparent area in the second sensor area,
wherein the second optically transparent area has a third light transmission of greater than about 16% and less than about 85% at about 850 nm.

7. A multiple layer panel of claim 1:
wherein the multiple layer panel has a sensor area for at least a first sensor and a second sensor, and
wherein the first polymer interlayer has a solar absorbing capability with a first visible light transmission of less than 90% at about 905 nm,
wherein the first sensor area comprises a second polymer interlayer selected to allow a first optically transparent area in the first sensor area, wherein the first optically transparent area has a second visible light transmission of greater than 90% at about 905 nm, and
wherein the second sensor area comprises a pattern on at least one of the first rigid substrate, the second rigid substrate and/or the second polymer interlayer selected to allow a second optically transparent area in the second sensor area,
wherein the second optically transparent area has a third visible light transmission of greater than about 16% and less than about 85% at about 850 nm.

8. The multiple layer panel of claim 7, wherein the first and second rigid substrates are low iron or ultra-clear glass.

9. The multiple layer panel of claim 8, wherein the multiple layer panel is a windshield.

10. A method of making a multiple layer panel, the method comprising the steps of:
providing a first rigid substrate,
providing a first polymer interlayer and placing the first polymer interlayer on the first rigid substrate, and
providing a second rigid substrate,
wherein the first polymer interlayer has a sensor area having a first sensor area and a second sensor area, and wherein the first polymer area has a solar absorbing capability with a first visible light transmission of less than 90% at about 905 nm, and wherein the first sensor area comprises a second polymer interlayer selected to allow a first optically transparent area in the first sensor area, wherein the first optically transparent area has a second visible light transmission of greater than 90% at about 905 nm, and wherein the second sensor area comprises a third polymer interlayer selected to allow a second optically transparent area in the second sensor area, wherein the second optically transparent area has a third visible light transmission of greater than about 16% and less than about 85% at about 850 nm,
wherein the first polymer interlayer, the second polymer interlayer and the third polymer interlayer are different.

11. The method of claim 10, wherein the second polymer interlayer is a clear polymer interlayer.

12. The method of claim 11, wherein the third polymer interlayer is a colored polymer interlayer.

13. The method of claim 12, wherein the third polymer interlayer is a colored polymer interlayer having a color that is green, blue, grey, bronze, or a combination of green, blue, grey and bronze

14. A method of making a multiple layer panel, the method comprising the steps of:
providing a first rigid substrate,
providing a first polymer interlayer and placing the first polymer interlayer on the first rigid substrate, and
providing a second rigid substrate,
wherein the first polymer interlayer has a sensor area having a first sensor area and a second sensor area, and wherein the first polymer area has a solar absorbing capability with a first visible light transmission of less than 90% at about 905 nm, and wherein the first sensor area comprises a second polymer interlayer selected to allow a first optically transparent area in the first sensor area, wherein the first optically transparent area has a second visible light transmission of greater than 90% at about 905 nm, and wherein the second sensor area comprises a pattern on at least one of the first rigid substrate, the second rigid substrate and/or the second polymer interlayer selected to allow a second optically transparent area in the second sensor area, wherein the second optically transparent area has a third visible light transmission of greater than about 16% and less than about 85% at about 850 nm, and wherein the first polymer interlayer and the second polymer interlayer are different.

15. (canceled)

16. The method of claim 14, wherein the first and second rigid substrates are low iron or ultra-clear glass.

17. The method of claim 15, wherein the multiple layer panel is a windshield.
